(19) United States
(12) Patent Application Publication
(10) Pub. No.: US 2008/0107806 A1
(43) Pub. Date: May 8, 2008

(54) Method for Coating a Wall Flow Filter With a Coating Composition

(75) Inventors: Bernd Mergner, Rheinfelden (DE); Wolfgang Hasselmann, Rheinfelden (DE)

Correspondence Address: KALOW & SPRINGUT LLP, 488 MADISON AVENUE, 19TH FLOOR, NEW YORK, NY, 10022, US

(73) Assignee: UMICORE AG & CO.KG, Hanau-Wolfgang (DE)

(21) Appl. No.: 11/660,841

(22) PCT Filed: Aug. 13, 2005
(86) PCT No.: PCT/EP05/08826

§ 371 Date: Oct. 25, 2007

(30) Foreign Application Priority Data
Aug. 21, 2004 (DE) 10 2004 040 551.4

(51) Int. Cl. B05D 1/24

(52) U.S. Cl. 427/185; 427/244

(57) ABSTRACT

Wall-flow filters can be reproducibly provided with a catalytically active coating by providing a defined quantity of a coating composition and sucking this coating composition through the openings of the entry passages into the filter body. The coating composition is sucked in by applying a subatmospheric pressure to the openings of the exit passages of the wall-flow filters. A different ratio of the coating quantities on the inner surfaces (pore surfaces) and outer surfaces (geometric surfaces of the passage walls) forms depending on the type of coating composition—suspension of fine-particle solids, colloidal solution or solution of soluble precursors of catalytically active components.

The invention relates to a process for coating a particulate filter designed as a wall-flow filter with a coating composition. In particular, the invention relates to a process for coating a filter of this type for an exhaust-gas purification system of a diesel engine with a catalytically active coating.

What are known as wall-flow filters are increasingly being used to remove soot from the exhaust gas from diesel engines. They are generally cylindrical in shape, with two end faces and a lateral surface, and have a multiplicity of flow passages for the exhaust gases from the diesel engines located substantially parallel to the cylinder axis, running from the first end face to the second end face. The cross-sectional shape of the wall-flow filters depends on the installation requirements imposed on the motor vehicle. Filter bodies which are round, elliptical or triangular in cross section are in widespread use. The flow passages are generally square in cross section and are arranged in a dense pattern over the entire cross section of the filter bodies. The passage or cell density of the flow passages varies between 10 and 140 cm⁻¹, depending on the particular application. The thickness of the passage walls between two adjacent flow passages is typically from 0.1 to 0.3 mm, depending on the cell density.

To produce the filter action, the flow passages are sealed alternately at the first and second end faces. Depending on the arrangement of the filter in the exhaust-gas stream from the diesel engine, one end face forms the entry end face and the second end face forms the exit end face for the exhaust gas. The flow passages which are open at the entry side form the entry passages, and the flow passages which are open at the exit side form the exit passages. Entry and exit passages are alternately adjacent and are separated from one another by the passage walls between them.

On its way through the filter, the exhaust gas has to change over from the entry passages into the exit passages of the filter through the passage walls between the entry and exit passages. For this purpose, the material from which the wall-flow filters are produced has an open porosity. As the gas passes through the passage walls, the soot particulates which it contains are filtered out and substantially deposited on the passage walls of the entry passages.

The deposition of the soot causes a continuous increase in the exhaust-gas back pressure of the filter and reduces the performance of the engine. Consequently, the filter has to be regenerated from time to time by burning off the soot. To assist this measure, it is known for the filter to be coated with what is known as a soot ignition coating. Furthermore, the filter may also be coated with other catalysts.

To coat a filter with a catalytically active coating, the filter may, in accordance with German Laid-open specification DE 32 32 729 A1 (corresponding to U.S. Pat. No. 4,515,758), be impregnated, for example, with a solution of precursors of the desired coating materials and then dried. Alternatively, the filter may also have a suspension of fine-particle catalyst materials poured over it from one side and may then be dried and calcined. The suspension may additionally contain dissolved precursors of catalytically active components.

U.S. Pat. No. 4,759,918 describes a process for reducing the ignition temperature of diesel soot. For this purpose, a wall-flow filter is coated with a sulphur-resistant inorganic oxide selected from titanium oxide, zirconium oxide, silicon dioxide, aluminium silicate and aluminium oxide. Moreover, the wall-flow filter also contains at least one catalytically active element selected from the group consisting of platinum palladium and rhodium. This document does not provide any details as to a process for coating the wall-flow filters. In the examples, to simplify the measurements, only conventional flow-through honeycomb bodies are provided with the catalytic coatings by being immersed in a corresponding coating composition.

U.S. Pat. No. 5,492,679 describes a wall-flow filter, the walls of the entry passages of which are coated with an adsorber coating of zeolites for adsorbing hydrocarbons, while an oxidation catalyst is applied to the walls of the exit passages. The patent does not give any information as to how the coating is to be performed.

These examples show that catalytically coated wall-flow filters are increasingly being considered for purifying the exhaust gases from diesel engines. However, it is clear that there is not yet a fully technically developed process for coating these filters which would enable the filters to be coated reproducibly in large numbers.

By contrast, coating processes which allow the coating of what are known as flow-through honeycomb bodies, or honeycomb bodies for short, as are used in large numbers for exhaust-gas purification in the automotive industry, to be coated in large numbers are known. One example of such processes is that described in U.S. Pat. No. 4,550,034. According to this process, a pre-weighed quantity of the coating composition is introduced into a dish with a flat base. Then, the honeycomb body that is to be coated is partially immersed, at its lower end, in the coating composition, and the entire quantity of the coating composition is sucked into the passages through the honeycomb body by a subatmospheric pressure applied to the upper end of the honeycomb body.

One important criterion of a coating process is the coating or loading concentration which can be achieved with it in a single operation. This concentration is to be understood as meaning the solids content which remains behind on the honeycomb body after drying and calcining. The coating concentration is given in grams per liter volume of the carriers (g/l). In practice, coating concentrations of up to 300 g/l are required for automobile exhaust-gas catalysts. If this quantity cannot be applied in a single operation by the process used, the coating operation has to be repeated, after drying and if appropriate calcining of the honeycomb body, a sufficient number of times for the desired loading to be achieved. Two or more coating operations with different coating compositions are often carried out. This produces catalysts which have a plurality of layers with different catalytic functions on top of one another.

The coating process described has been developed for the coating of flow-through honeycomb bodies. As has already been determined above, on the other hand, there is not yet a fully technically developed process for coating wall-flow filters. Therefore, it is an object of the present invention to provide a process of this type.

This object is achieved by a process comprising the following process steps:
a) vertically orienting the flow passages of the wall-flow filter, so that one end face is at the bottom and the second end face is at the top,
b) immersing the lower end face of the wall-flow filter into a predefined quantity of the coating composition, and
c) applying a subatmospheric pressure to the openings of the exit passages in the upper end face and sucking all of the coating composition into the entry and exit passages through the openings of the entry passages in the lower end face,
   the predefined quantity of the coating composition being selected according to the desired coating concentration and coating height.

Depending on the desired coating result, the particulate filter may be oriented in such a way during the coating operation that the entry end face or the exit end face forms the lower end face.

The invention is explained in more detail with reference to the figures, in which:

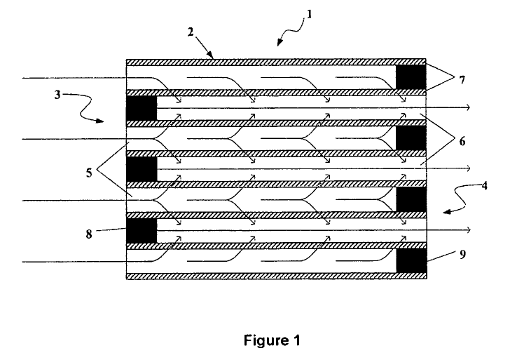

FIG. 1: shows a cross section through a wall-flow filter,

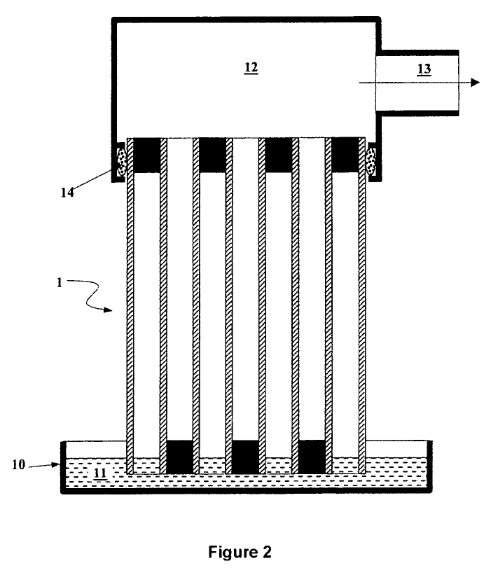

FIG. 2: shows an apparatus for coating the wall-flow filter.

FIG. 1 diagrammatically depicts a longitudinal section through a wall-flow filter (1). The filter is cylindrical in shape, with a lateral surface (2), an entry end face (3) and an exit end face (4). The filter has flow passages (5) and (6) for the exhaust gas over its cross section, which flow passages are separated from one another by the passage walls (7). The flow passages are alternately sealed at the entry end face and the exit end face by gastight plugs (8) and (9). The flow passages (5) that are open at the entry side form the entry passages for the exhaust gas, and the flow passages (6) that are open at the exit side form the exit passages for the exhaust gas. The exhaust gas which is to be purified enters the entry passages of the filter, and to pass through the filter has to pass from the entry passages into the exit passages through the porous passage walls (7).

Tests carried out by the inventors have shown that wall-flow filters of the type shown in FIG. 1 can, surprisingly, be coated using a process similar to that described in U.S. Pat. No. 4,550,034, despite the fact that this was unexpected on account of the quite different nature of the action of the subatmospheric pressure applied. According to the invention, the subatmospheric pressure is applied to the openings of the exit passages, while the coating composition is sucked into the wall-flow filter through the openings of the entry passages. The filter action separates the constituents of the coating composition to a greater or lesser extent depending on the type of coating composition. When carrying out the process, the subatmospheric pressure does not have to be applied to each opening of the exit passages separately, but rather it is sufficient for the subatmospheric pressure to act on the whole of the upper end face of the wall-flow filter. The plugs closing up the entry passages at the upper end face are virtually impermeable, so that the subatmospheric pressure can only act through the openings of the exit passages.

The process described can be used to coat all wall-flow filters which are currently customary; in this context, mention may be made, for example, of wall-flow filters made from cordierite, silicon carbide or aluminium titanate. These filters have cell densities (number of entry and exit passages per unit cross-sectional area of the filter) of between 31 and 93 cm⁻², with wall thicknesses of the passage walls of between 0.3 and 0.1 mm. The porosity of these filters may be between 30 and 95%, while the mean pore diameters are between 10 and 50 μm. The porosity is preferably between 45 and 90%. By contrast, the porosity of conventional, ceramic flow-through honeycomb bodies, at approximately 30%, is at the lower end of the porosity range of wall-flow filters. The difference is even clearer with regard to the mean pore diameter, which in the case of conventional flow-through honeycomb bodies is only approximately 4 to 5 μm.

FIG. 2 shows one possible embodiment of an apparatus for coating the wall-flow filter (1) in accordance with the invention. A defined quantity of the coating composition (11) is placed into a dish (10) with a flat base. The diameter of the dish corresponds at least to the largest cross-sectional dimension of the wall-flow filter. The wall-flow filter is immersed into the coating composition to a depth which is such that the gap which remains between the lower end face and the base of the dish amounts to between 0.5 and 2 mm. To suck up the coating composition, an extractor hood (12) is fitted onto the upper end face and sealed against the lateral surface of the filter by means of an optionally inflatable rubber seal (14). Subatmospheric pressure is applied to the extractor hood via suction connection piece (13), and as a result the coating composition is sucked into the flow passages of the filter which are open at the bottom. In the process, the coating composition passes through the porous passage walls and into the flow passages that are closed at the bottom and open at the top.

The subatmospheric pressure which is applied to the upper end face to suck up the coating composition is advantageously increased, starting from a low level, as the suction time progresses. By way of example, the subatmospheric pressure applied can be increased in two successive stages, with the subatmospheric pressure in the second stage being higher than in the first stage. It is preferable for the subatmospheric pressure in the first stage to be set to be between 100 and 200 Pa, and for the subatmospheric pressure in the second stage to be increased to 500 to 5000 Pa. The suction time for the first stage may be between 1 and 10 seconds, and the suction time for the second stage may be between 10 and 50 seconds.

After the coating operation has been carried out, the wall-flow filter is dried at elevated temperature and then calcined at a temperature between 300 and 600° C.

The coating composition may be a suspension of fine-particle solids, a colloidal solution or a solution of soluble precursors of the subsequent coating materials, which are only converted into the coating materials by the final calcination. Mixed forms of these three coating compositions are also possible.

In the context of the present invention, the term fine-particle solids is to be understood as meaning pulverulent substances with particle diameters of between 1 and 50 μm, which have a specific surface area of between 10 and 400 m²/g. Materials of this type are used in catalysis as support materials for catalytically active precious metals from the group of the platinum group metals. Accordingly, the fine-particle solids used here may also be catalytically activated with at least one platinum group metal.

In the context of the present invention, therefore, the term “fine-particle solids” includes in particular the support materials for catalytically active components which are customarily used in catalysis, such as for example the precious metals of the platinum group and also support materials which have already been coated with these components.

Prior to the coating operation, the solids of the coating composition are usually milled to a mean particle size d₅₀ of between 2 and 4 μm. The designation d₅₀ indicates that the volume of the particles with particle sizes below d₅₀ cumulatively adds up to 50% of the volume of all the particles. Although the particle size of 2 to 4 μm is significantly smaller than the mean pore size of the wall-flow filter, the latter nonetheless exerts a significant filter action on the solids contained in the coating composition during the coating operation. Therefore, the majority of these substances are deposited on the outer, geometric surfaces of the walls of the entry passages. Only a smaller proportion penetrates into the pores, where it coats the inner surfaces of the pores. One probable reason for this is the fact that the pore openings in the passage walls are significantly smaller than the pore diameters themselves, and can therefore be closed up even by relatively small particles.

The mass ratio of the solid particles which have been deposited in the pores in the wall-flow filters to the solid particles which have been deposited on the geometric surface of the filter can be influenced by the milling operation. When coating conventional flow-through honeycomb bodies, the coating composition is usually milled to a mean particle size of 2 to 4 μm. This mean particle size guarantees good bonding of the particles to the geometric surfaces of the honeycomb bodies. If the mean particle size is reduced by milling to below 2 to 4 μm, experience has shown that the bonding to the geometric surfaces of the honeycomb bodies is reduced, which leads to the coating flaking off. This does not apply in the present case of coating wall-flow filters. In this context, it may even be desirable for the coating composition to be particularly finely milled, in order for as high a proportion of the particles as possible to be deposited in the pores in the filter. In this context, there is no risk of the coating flaking off, since the particularly fine particles are secured within the pores.

In addition to the fine-particle solids, the coating composition may additionally contain soluble precursors of further catalytically active components, which are converted into their final form during the final drying and calcining of the coating at temperatures of between 300 and 600° C.

Colloidal solutions can also particularly advantageously be used as coating composition for the coating process. Colloidal solutions contain what are known as sols. These are preshaped solids with a particle diameter of less than 1 μm, preferably less than 0.5 μm. Virtually all known catalytic support materials are also available as sols of this type.

If a colloidal solution of this type is used as coating composition, the majority of the colloidal material is deposited in the pores in the wall-flow filter. Only a smaller proportion forms a coating on the geometric wall surfaces of the entry and exit passages.

Coating variants which are of interest result if the coating composition used comprises two materials with different catalytic functions, one material having a mean grain size which ensures that it is deposited in the pores in the wall-flow filter, while the second material has a mean grain size which substantially prevents this material from penetrating into the pores in the filter. A common coating composition can be produced from the two materials. In this case, on account of the different grain sizes, during the coating operation the material with the small grain size is substantially deposited in the pores in the filter, whereas the coarser material is substantially deposited on the passage walls of the flow passages which form the entry passages during coating.

In particular, the coating composition may be a mixture of a suspension of fine-particle solids and a colloidal solution. The coating composition then has a multimodal distribution of the grain sizes, with at least one maximum of the grain size distribution below 1 μm and a second maximum above 1 μm.

In a further embodiment of the process, there is provision for an aqueous solution of precursors of the subsequent coating materials to be used as coating composition. Following the coating operation, the precursors are converted into the actual coating materials by drying and calcining. When impregnating the wall-flow filter in this way, the coating material is substantially deposited in the pores in the wall-flow filter, in a similar way as when using a colloidal solution.

The process can be used to apply coating concentrations of 100 g/l in a single operation. Since the exhaust-gas back pressure of the filter increases with an increasing coating concentration, which has an adverse effect on the power of the diesel engine whereof the exhaust gas is to be treated using the filter, the maximum coating concentration to be applied is less than 75 g/l, particularly preferably less than 50 g/l.

These coating concentrations can be achieved with all three types of coating composition (suspension of fine-particle solids, colloidal solution or solution of precursors of the catalytically active components). In the case of the suspension, the solids concentration of the coating composition is from 10 to 20% by weight. The viscosity is between 0.01 and 0.5 Pa.s.

1. Process for coating a wall-flow particulate filter with a coating composition, the particulate filter being produced from an open-pore material, being cylindrical in shape with length L and having a multiplicity of flow passages, which are closed off on alternate sides, running from an entry end face to an exit end face, characterized by the process steps of
a) vertically orienting the flow passages of the wall-flow filter, so that one end face is at the bottom and the second end face is at the top,
b) immersing the lower end face of the wall-flow filter into a predefined quantity of the coating composition, and
c) applying a subatmospheric pressure to the openings of the exit passages in the upper end face and sucking all of the coating composition into the entry and exit passages through the openings of the entry passages in the lower end face,
the predefined quantity of the coating composition being selected according to the desired coating concentration and coating height.

2. Process according to claim 1, characterized in that the wall-flow filter has a porosity of from 30 to 95%, with mean pore diameters between 10 and 50 μm.

3. Process according to claim 2, characterized in that the particulate filter is produced from cordierite, from silicon carbide or from aluminium titanate.

4. Process according to claim 1, characterized in that the defined quantity of the coating composition is placed in a dish with a flat base, the diameter of which corresponds at least to the largest cross-sectional diameter of the wall-flow filter, and the wall-flow filter is immersed in the coating composition to a depth which is such that the gap which remains between the lower end face and the base of the dish is between 0.5 and 2 mm.

5. Process according to claim 1, characterized in that the dynamic viscosity of the coating composition is between 0.01 and 0.5 Pa.s.

6. Process according to claim 4, characterized in that the subatmospheric pressure applied to the upper end face is increased, starting from a low value, as the suction time progresses.

7. Process according to claim 6, characterized in that the subatmospheric pressure is applied in two successive stages, with the subatmospheric pressure in the second stage being higher than in the first stage.

8. Process according to claim 7, characterized in that the subatmospheric pressure in the first stage is set to between 100 and 200 Pa, and the subatmospheric pressure in the second stage is increased to 500 to 5000 Pa.

9. Process according to claim 8, characterized in that the subatmospheric pressure in the first stage is applied to the upper end face of the wall-flow filter for a duration of 1 to 10 seconds, and the subatmospheric pressure in the second stage is applied to the upper end face of the wall-flow filter for a duration of 10 to 50 seconds.

10. Process according to claim 1, characterized in that the coating is finally dried at elevated temperature and then calcined at a temperature of between 300 and 600° C.

11. Process according to claim 1, characterized in that the coating composition is a suspension of fine-particle solids.

12. Process according to claim 11, characterized in that the coating composition, as fine-particle solids, contains pulverulent support materials with a specific surface area of between 10 and 400 m²/g and particle sizes of between 1 and 50 μm, to which catalytically active precious metals from the group of the platinum group metals have been applied.

13. Process according to claim 12, characterized in that the coating composition additionally contains soluble precursors of further catalytically active components.

14. Process according to claim 13, characterized in that the coating is finally dried at elevated temperature and then calcined at a temperature of between 300 and 600° C., with the precursors of the catalytically active components being converted into their final form.

15. Process according to claim 8, characterized in that the fine-particle solids of the coating composition have a mean particle diameter of less than 1 μm.

16. Process according to claim 8, characterized in that the fine-particle solids of the coating composition have a multimodal grain size distribution with at least one maximum of the grain size distribution below 1 μm and a second maximum above 1 μm.

17. Process according to claim 1, characterized in that the coating composition is an aqueous solution of precursors of the subsequent coating materials, which after the coating step are converted into the actual coating materials by drying and calcining.
